(19) United States
(12) Patent Application Publication
(10) Pub. No.: US 2026/0309033 A1
(43) Pub. Date: Oct. 8, 2026

(54) INTERNAL BAFFLE FOR A GAS TURBINE ENGINE VANE

(71) Applicant: RTX Corporation, Farmington, CT (US)

(72) Inventors: Brendan Harders, West Hartford, CT (US); Dawit Dereje, Lake Worth, FL (US); Shawn M. McMahon, Laurel, MD (US)

(21) Appl. No.: 19/169,725

(22) Filed: Apr. 3, 2025

(51) Int. Cl. F01D 5/18; F01D 9/04

(52) U.S. Cl. CPC F01D 5/18; F01D 9/041; F05D 2230/60; F05D 2260/83

(57) ABSTRACT

A turbine vane includes a vane body and a baffle. The vane body includes an inner side forming an internal cavity. The vane body further forms at least one retention feature recess on the inner side. The baffle is disposed within the internal cavity. The baffle includes a tubular body. The tubular body subdivides the internal cavity into an outer cavity portion and an inner cavity portion. The outer cavity portion is formed between the inner side and the baffle tubular body. The inner cavity portion is circumscribed by the tubular body. The tubular body includes at least one protruding retention feature. The at least one protruding retention feature is disposed within the at least one retention feature recess. The at least one protruding retention feature disposed within the at least one retention feature recess obstructs radial movement of the baffle relative to the vane body.

### BACKGROUND

### 1. Technical Field

This disclosure relates generally to gas turbine engines for aircraft propulsion systems and, more particularly, to internal baffles for gas turbine engine vanes.

### 2. Background Information

A gas turbine engine typically includes a turbine section. The turbine section may include one or more turbines such as, but not limited to, a low-pressure turbine and a high-pressure turbine. These turbines may include multiple stages of blades and vanes. As fluid flows through the turbine section, the flow causes the blades to rotate about an axis of rotation. The vanes may be used to redirect this fluid flow to improve the effectiveness of the fluid for driving rotation of the downstream blades. Various turbine vane configurations are known in the art. While these known turbine vane configurations may be suitable for their intended purposes, there is always room in the art for improvement.

### SUMMARY

According to an aspect of the present disclosure, a turbine vane of a gas turbine engine for an aircraft propulsion system includes a vane body and a baffle. The vane body extends between and to an outer radial vane end and an inner radial vane end. The vane body includes an inner side forming an internal cavity extending through the vane body between the outer radial vane end and the inner radial vane end. The vane body further forms at least one retention feature recess on the inner side. The baffle is disposed within the internal cavity. The baffle extends between and to an outer radial baffle end and an inner radial baffle end. The baffle includes a tubular baffle body extending between and to the outer radial baffle end and the inner radial baffle end. The tubular baffle body subdivides the internal cavity into an outer cavity portion and an inner cavity portion. The outer cavity portion is formed between the inner side and the baffle tubular baffle body. The inner cavity portion is circumscribed by the tubular baffle body. The tubular baffle body includes at least one protruding retention feature. The at least one protruding retention feature is disposed within the at least one retention feature recess. The at least one protruding retention feature disposed within the at least one retention feature recess obstructs radial movement of the baffle relative to the vane body.

In any of the aspects or embodiments described above and herein, the vane body may include a pressure side wall and a suction side wall, the pressure side wall and the suction side wall may include portions of the inner side forming the internal cavity, and one or both of the pressure side wall or the suction side wall may form the at least one retention feature recess.

In any of the aspects or embodiments described above and herein, the tubular baffle body may include an outer surface forming the outer cavity portion, the outer surface may include a baffle pressure side and a baffle suction side, the baffle pressure side may face the pressure side wall, the baffle suction side may face the suction side wall, and the at least one protruding retention feature may be disposed on one or both of the baffle pressure side or the baffle suction side.

In any of the aspects or embodiments described above and herein, the at least one retention feature recess may include a first retention feature recess and a second retention feature recess, the at least one protruding retention feature may include a first protruding retention feature and a second protruding retention feature, the first protruding retention feature may be disposed within the first retention feature recess, and the second protruding retention feature may be disposed within the second retention feature recess.

In any of the aspects or embodiments described above and herein, the at least one retention feature recess may be recessed from surrounding portions of the inner side, the vane body may include a rim forming an outer radial recess end of the at least one retention feature recess, and the at least one protruding retention feature may project outward from surrounding portions of the tubular baffle body into the at least one retention feature recess at the rim.

In any of the aspects or embodiments described above and herein, the at least one protruding retention feature may include a retention tab formed by the tubular baffle body, the retention tab may project into the at least one retention feature recess and obstruct radial movement of the baffle relative to the vane body.

In any of the aspects or embodiments described above and herein, the retention tab may extend between and to an inner radial tab end and an outer radial tab end and between and to a first lateral tab end and a second lateral tab end, the inner radial tab end may be formed by a bend of the tubular baffle body interconnecting the retention tab with a remainder of the tubular baffle body, and each of the outer radial tab end, the first lateral tab end, and the second lateral tab end may be separated from surrounding portions of the tubular baffle body.

In any of the aspects or embodiments described above and herein, the tubular baffle body may form an aperture coincident with the retention tab, and the aperture may extend through the tubular baffle body from the inner cavity portion to the outer cavity portion.

In any of the aspects or embodiments described above and herein, the at least one protruding retention feature may include a protruding bulge segment formed by the tubular baffle body, and the protruding bulge segment may extend into the at least one retention feature recess and obstruct radial movement of the baffle relative to the vane body.

In any of the aspects or embodiments described above and herein, the protruding bulge segment may be formed by a continuous portion of the tubular baffle body.

According to another aspect of the present disclosure, a method for installing a baffle in a turbine vane of a gas turbine engine of an aircraft propulsion system includes accessing the turbine vane through an access port of an engine case of the gas turbine engine and removing the baffle from an internal cavity of the turbine vane by separating at least one protruding retention feature of the baffle from at least one retention feature recess formed by a vane body of the turbine vane. The vane body forms the internal cavity of the turbine vane with the at least one retention feature recess disposed coincident with the internal cavity.

In any of the aspects or embodiments described above and herein, removing the baffle from the internal cavity of the turbine vane may further include removing the baffle from the gas turbine engine through the access port.

In any of the aspects or embodiments described above and herein, the steps of accessing the turbine vane and removing the baffle from the internal cavity of the turbine vane may be performed with the propulsion system installed on an aircraft.

In any of the aspects or embodiments described above and herein, the method may further include inspecting a bladed turbine rotor of the gas turbine engine disposed adjacent the turbine vane subsequent to removing the baffle from an internal cavity of the turbine vane and installing the baffle into the turbine vane at the internal cavity subsequent to inspecting the bladed turbine rotor.

According to another aspect of the present disclosure, a method for installing a baffle into a turbine vane of a gas turbine engine of an aircraft propulsion system includes inserting the baffle into an internal cavity of the turbine vane and installing the baffle in the turbine vane by inserting the baffle until at least one protruding retention feature of the baffle expands into at least one retention feature recess formed by a vane body of the turbine vane. The vane body forms the internal cavity of the turbine vane with the at least one retention feature recess disposed coincident with the internal cavity.

In any of the aspects or embodiments described above and herein, the method may further include accessing the turbine vane through an access port of an engine case of the gas turbine engine prior to installing the baffle in the internal cavity, and installing the baffle into the turbine vane may further include installing the baffle into the gas turbine engine through the access port.

In any of the aspects or embodiments described above and herein, the steps of accessing the turbine vane and installing the baffle may be performed with the propulsion system installed on an aircraft.

In any of the aspects or embodiments described above and herein, the method may further include inspecting a bladed turbine rotor of the gas turbine engine disposed adjacent the turbine vane, and installing the baffle into the turbine vane may be performed subsequent to inspecting the bladed turbine rotor.

According to another aspect of the present disclosure, a gas turbine engine for an aircraft propulsion system includes a bladed turbine rotor and a turbine vane stage. The bladed turbine rotor is rotatable about a rotational axis of the gas turbine engine. The bladed turbine rotor includes an upstream rotor stage and a downstream rotor stage. The turbine vane stage disposed axially between the upstream rotor stage and the downstream rotor stage. The turbine vane stage includes a plurality of turbine vanes. At least one of the plurality of turbine vanes includes a vane body and a baffle. The vane body extends between and to an outer radial vane end and an inner radial vane end. The vane body includes an inner side forming an internal cavity extending through the vane body between the outer radial vane end and the inner radial vane end. The vane body further forms at least one retention feature recess on the inner side at the outer radial vane end. The baffle is disposed within the internal cavity. The baffle includes at least one protruding retention feature. The at least one protruding retention feature is disposed within the at least one retention feature recess. The at least one protruding retention feature is disposed within the at least one retention feature recess obstructing radial movement of the baffle relative to the vane body.

In any of the aspects or embodiments described above and herein, the at least one protruding retention feature may include a retention tab, the retention tab may project into the at least one retention feature recess and obstruct radial movement of the baffle relative to the vane body.

In any of the aspects or embodiments described above and herein, the retention tab may extend between and to an inner radial tab end and an outer radial tab end and between and to a first lateral tab end and a second lateral tab end, the inner radial tab end may be formed by a bend of the baffle with the retention tab projecting outward from the bend into the at least one retention feature recess, and each of the outer radial tab end, the first lateral tab end, and the second lateral tab end may be separated from surrounding portions of the baffle.

In any of the aspects or embodiments described above and herein, the baffle may form an aperture coincident with the retention tab.

In any of the aspects or embodiments described above and herein, the at least one protruding retention feature may include a protruding bulge segment extending into the at least one retention feature recess and obstructing radial movement of the baffle relative to the vane body.

In any of the aspects or embodiments described above and herein, the protruding bulge segment may be formed by a continuous portion of the baffle.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 illustrates a perspective view of an aircraft including a propulsion system, in accordance with one or more embodiments of the present disclosure.

FIG. 2 schematically illustrates a cutaway, side view of an aircraft propulsion system including a gas turbine engine, in accordance with one or more embodiments of the present disclosure.

FIG. 3 schematically illustrates a portion of a turbine section of the gas turbine engine including a turbine vane stage, in accordance with one or more embodiments of the present disclosure.

FIG. 4 schematically illustrates a cutaway view of a turbine vane including an internal baffle, in accordance with one or more embodiments of the present disclosure.

FIG. 5 schematically illustrates an inspection system, in accordance with one or more embodiments of the present disclosure.

FIG. 6 illustrates a perspective view of an internal baffle including a protruding retention feature, in accordance with one or more embodiments of the present disclosure.

FIG. 7 illustrates a cutaway, side view of the turbine vane and the internal baffle of FIG. 6, in accordance with one or more embodiments of the present disclosure.

FIG. 8 illustrates a cutaway, side view of the turbine vane and another internal baffle, in accordance with one or more embodiments of the present disclosure.

### DETAILED DESCRIPTION

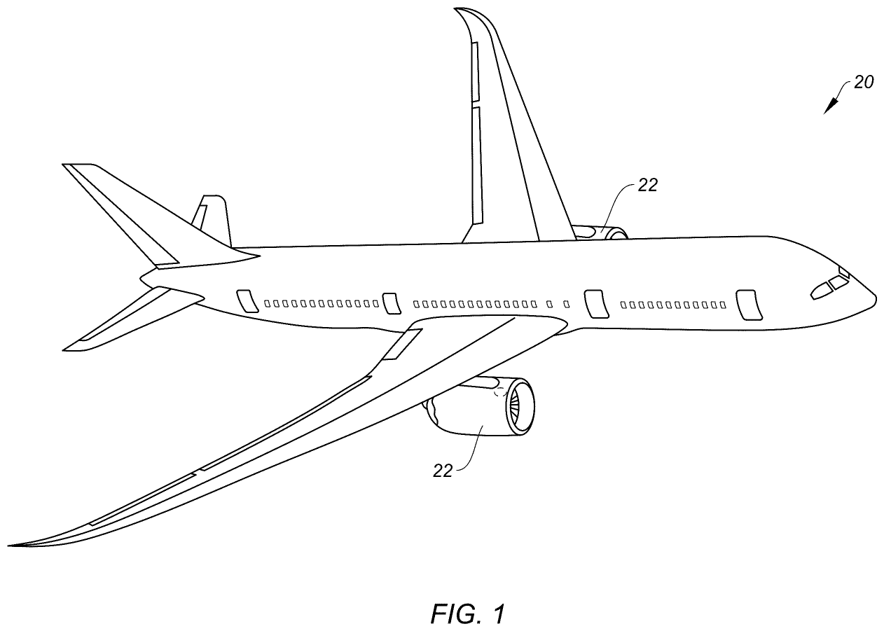

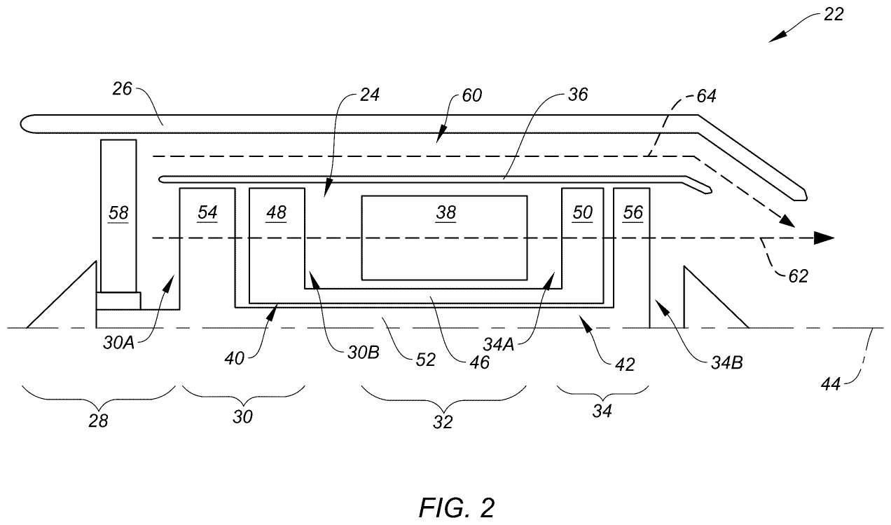

FIG. 1 illustrates an aircraft 20 including a propulsion system 22. Briefly, the aircraft 20 may be a fixed-wing aircraft (e.g., an airplane), a rotary-wing aircraft (e.g., a helicopter), a tilt-rotor aircraft, a tilt-wing aircraft, or another aerial vehicle. Moreover, the aircraft 20 may be a manned aerial vehicle or an unmanned aerial vehicle (UAV, e.g., a drone). FIG. 2 schematically illustrates a cutaway, side view of the propulsion system 22. The propulsion system 22 of FIG. 2 includes a gas turbine engine 24 and a nacelle 26.

The gas turbine engine 24 of FIG. 2 is configured as a multi-spool turbofan gas turbine engine 24. However, while the following description and accompanying drawings may refer to the turbofan gas turbine engine 24 of FIG. 2 as an example, it should be understood that aspects of the present disclosure may be equally applicable to other types of gas turbine engines including, but not limited to, a turboshaft gas turbine engine, a turboprop gas turbine engine, a turbojet gas turbine engine, and/or a propfan (e.g., an open rotor) gas turbine engine.

The gas turbine engine 24 of FIG. 2 includes a fan section 28, a compressor section 30, a combustor section 32, a turbine section 34, and an engine static structure 36. The compressor section 30 includes a low-pressure compressor (LPC) 30A and a high-pressure compressor (HPC) 30B. The combustor section 32 includes a combustor 38 (e.g., an annular combustor). The turbine section 34 includes a high-pressure turbine (HPT) 34A and a low-pressure turbine (LPT) 34B.

Components of the fan section 28, the compressor section 30, and the turbine section 34 form a first rotational assembly 40 (e.g., a high-pressure spool) and a second rotational assembly 42 (e.g., a low-pressure spool) of the gas turbine engine 24. The first rotational assembly 40 and the second rotational assembly 42 are mounted for rotation about a rotational axis 44 (e.g., an axial centerline) of the gas turbine engine 24 relative to the engine static structure 36.

The first rotational assembly 40 includes a first shaft 46, a bladed first compressor rotor 48 for the high-pressure compressor 30B, and a bladed first turbine rotor 50 for the high-pressure turbine 34A. The first shaft 46 interconnects the bladed first compressor rotor 48 and the bladed first turbine rotor 50.

The second rotational assembly 42 includes a second shaft 52, a bladed second compressor rotor 54 for the low-pressure compressor 30A, a bladed second turbine rotor 56 for the low-pressure turbine 34B, and a bladed fan rotor 58 for the fan section 28. The second shaft 52 interconnects the bladed second compressor rotor 54 and the bladed second turbine rotor 56. The second shaft 52 may additionally interconnect the bladed fan rotor 58 with the bladed second compressor rotor 54 and the bladed second turbine rotor 56. Alternatively, the second shaft 52 may be coupled with the bladed fan rotor 58 by a gear assembly (e.g., a reduction gear box (RGB)). The first shaft 46 and the second shaft 52 are concentric and configured to rotate about the rotational axis 44. The present disclosure, however, is not limited to concentric configurations of the first shaft 46 and the second shaft 52.

The engine static structure 36 may include one or more engine cases, cowlings, bearing assemblies, inner fixed structures, and/or other non-rotating structures configured to house and/or support (e.g., rotationally support) components of the gas turbine engine sections 28, 30, 32, 34. The engine static structure 36 may form an exterior (e.g., an outer radial portion) of the gas turbine engine 24.

The nacelle 26 is configured to house and form an aerodynamic cover for the gas turbine engine 24. The nacelle 26 may extend circumferentially about (e.g., completely around) the gas turbine engine 24 and its rotational axis 44. The nacelle 26 may circumscribe and form an annular bypass duct 60 through the propulsion system 22. For example, the bypass duct 60 may be formed by and between (e.g., radially between) the gas turbine engine 24 (e.g., the engine static structure 36) and the nacelle 26.

In operation of the gas turbine engine 24, ambient air is directed through the fan section 28 and into a core flow path 62 (e.g., an annular flow path) and a bypass flow path 64 (e.g., an annular flow path) by rotation of the bladed fan rotor 58. Air flow along the core flow path 62 is compressed by the low-pressure compressor 30A and the high-pressure compressor 30B, mixed and burned with fuel in the combustor 38, and then directed through the high-pressure turbine 34A and the low-pressure turbine 34B. The bladed first turbine rotor 50 and the bladed second turbine rotor 56 rotationally drive the first rotational assembly 40 and the second rotational assembly 42, respectively, in response to the combustion gas flow through the high-pressure turbine 34A and the low-pressure turbine 34B. Air flow along the bypass flow path 64 is directed through the bypass duct 60.

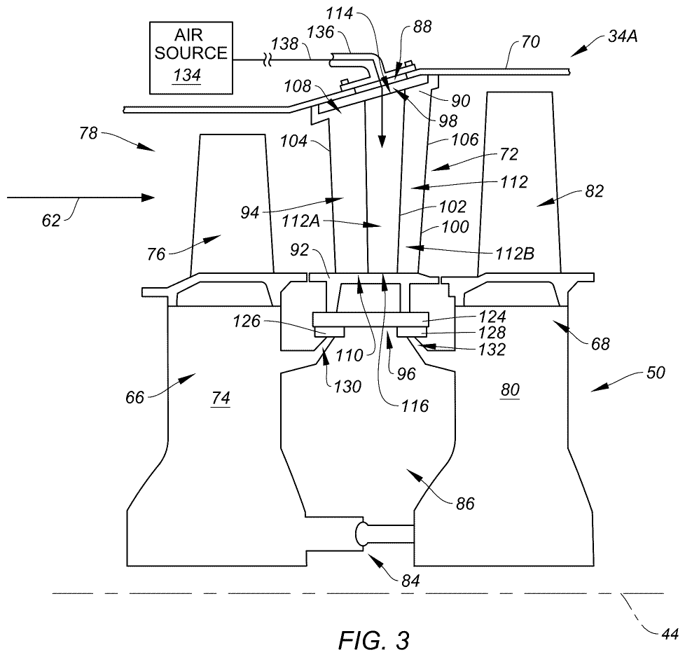

FIG. 3 schematically illustrates a portion of the high-pressure turbine 34A. The bladed first turbine rotor 50 of FIG. 3 includes an upstream rotor stage 66 and a downstream rotor stage 68. The engine static structure 36 of FIG. 3 includes an engine case 70 and a turbine vane stage 72.

The upstream rotor stage 66 includes a rotor disk 74 and a plurality of turbine blades 76. The rotor disk 74 extends circumferentially about (e.g., completely around) the rotational axis 44. The turbine blades 76 are mounted onto and arrayed circumferentially about the rotor disk 74. The turbine blades 76 extend radially outward from the rotor disk 74 into a core flow passage 78 (e.g., an annular core flow passage) through the high-pressure turbine 34A. Similarly, the downstream rotor stage 68 includes a rotor disk 80 and a plurality of turbine blades 82. The rotor disk 80 extends circumferentially about (e.g., completely around) the rotational axis 44. The turbine blades 82 are mounted onto and arrayed circumferentially about the rotor disk 80. The turbine blades 82 extend radially outward from the rotor disk 80 into the core flow passage 78. The rotor disk 74 and the rotor disk 80 may be mounted together at an attachment interface 84 between (e.g., axially between) the rotor disks 74, 80. The rotor disk 74 and the rotor disk 80 form a rotor cavity 86 (e.g., a sealed, annular rotor cavity) therebetween. The rotor cavity 86 is formed by and between (e.g., axially between) the rotor disk 74 and the rotor disk 80. The rotor cavity 86 may be further formed between (e.g., radially between) the attachment interface 84 and the turbine vane stage 72.

The engine case 70 extends circumferentially about (e.g., completely around) the rotational axis 44 and circumscribes the high-pressure turbine 34A. The engine case 70 forms an outer radial boundary of the core flow passage 78 through the high-pressure turbine 34A. The engine case 70 forms one or more turbine cooling air (TCA) ports 88 through (e.g., radially through) the engine case 70 at (e.g., on, adjacent, or proximate) the turbine vane stage 72.

The turbine vane stage 72 includes an outer ring 90, an inner ring 92, and a plurality of turbine vanes 94 collectively forming the turbine vane stage 72 (e.g., a vane assembly). The turbine vane stage 72 may additionally include a gas seal 96. The turbine vane stage 72 is disposed between (e.g., axially between) the upstream rotor stage 66 and the downstream rotor stage 68. The outer ring 90 and the inner ring 92 extend circumferentially about (e.g., completely around) the rotational axis 44. The outer ring 90 is mounted to or otherwise disposed at (e.g., on, adjacent, or proximate) the engine case 70. The outer ring 90 forms an air plenum 98 (e.g., an annular air plenum) at (e.g., on, adjacent, or proximate) and connected in fluid communication with the TCA ports 88. Each of the turbine vanes 94 is disposed between (e.g., radially between) the outer ring 90 and the inner ring 92. The turbine vanes 94 are arrayed circumferentially about the rotational axis 44 between the outer ring 90 and the inner ring 92.

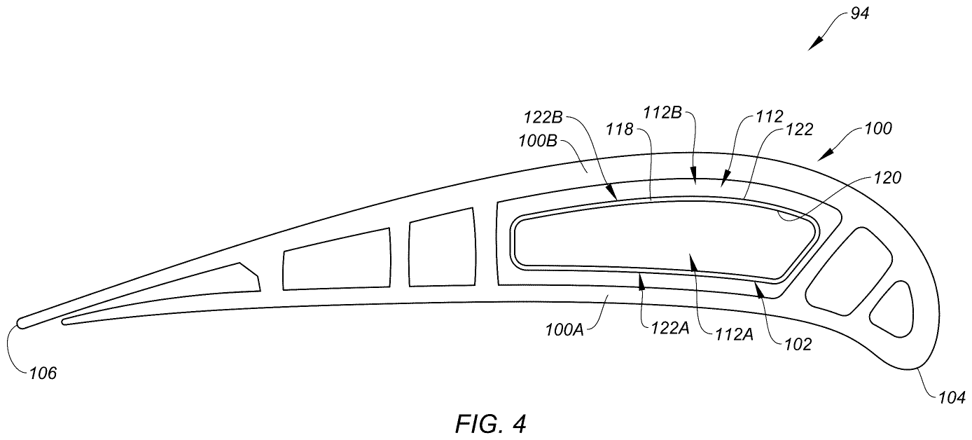

With additional reference to FIG. 4, each of the turbine vanes 94 includes a vane body 100 and an internal baffle 102. The vane body 100 is configured as an airfoil extending in a chordwise direction between and to a leading edge 104 of the vane body 100 and a trailing edge 106 of the vane body 100. The vane body 100 extends (e.g., radially extends) between and to an outer radial end 108 of the vane body 100 and an inner radial end 110 of the vane body 100. The vane body 100 includes a pressure side wall 100A and a suction side wall 100B. The pressure side wall 100A and the suction side wall 100B form a pressure side surface and a suction side surface of the vane body 100, respectively. The outer radial end 108 is mounted to or otherwise disposed at (e.g., on, adjacent, or proximate) the outer ring 90. The inner radial end 110 is mounted to or otherwise disposed at (e.g., on, adjacent, or proximate) the inner ring 92. The vane body 100 extends radially through the core flow passage 78 to guide combustion gas along the core flow path 62 onto the turbine blades 82 of the downstream rotor stage 68. The vane body 100 forms and surrounds at least one internal cavity 112 of the vane body 100 between the pressure side wall 100A and the suction side wall 100B. For example, the vane body 100 of FIG. 4 forms a plurality of internal cavities. The internal cavity 112 extends through (e.g., radially through) the vane body 100 between the outer radial end 108 and the inner radial end 110. The internal cavity 112 is open at the outer radial end 108 to connect the internal cavity 112 in fluid communication with the air plenum 98. The inner ring 92 encloses the internal cavity 112 at (e.g., on, adjacent, or proximate) the inner radial end 110. The internal cavity 112 may be aligned with (e.g., axially and circumferentially coincident with) one of the TCA ports 88.

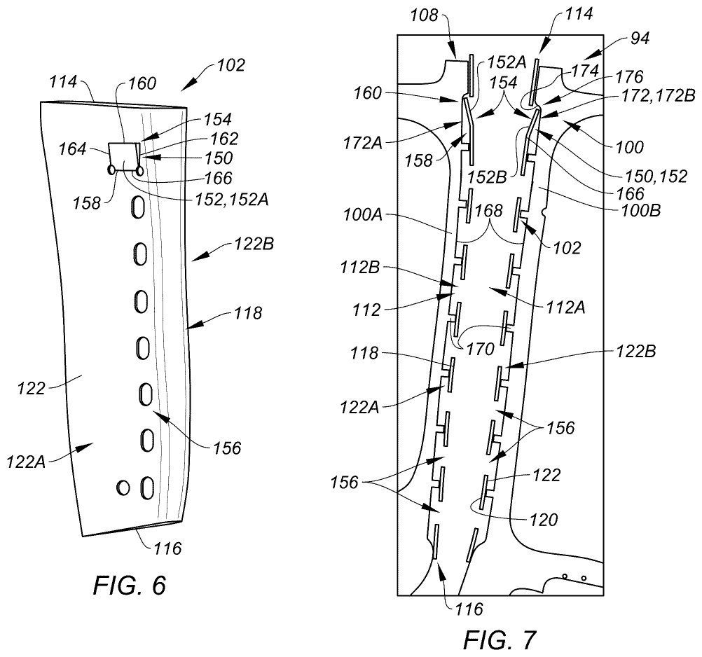

The baffle 102 is disposed within the internal cavity 112. The baffle 102 extends between and to an outer radial end 114 of the baffle 102 and an inner radial end 116 of the baffle 102. The outer radial end 114 is disposed at (e.g., on, adjacent, or proximate) the outer radial end 108. The inner radial end 116 is disposed at (e.g., on, adjacent, or proximate) the inner radial end 110. The baffle 102 may be formed as a baffle body 118 (e.g., a tubular, sheet-metal body) extending between and to the outer radial end 114 and the inner radial end 116 within the internal cavity 112. The baffle body 118 extends between and to an inner surface 120 of the baffle body 118 and an outer surface 122 of the baffle body 118. The baffle 102 subdivides the internal cavity 112 into an inner cavity portion 112A and an outer cavity portion 112B. The baffle 102 (e.g., the inner surface 120) circumscribes the inner cavity portion 112A between the outer radial end 114 and the inner radial end 116. The outer cavity portion 112B is formed by and between the vane body 100 and the baffle 102 (e.g., the outer surface 122). The outer surface 122 include a pressure side 122A and a suction side 122B. The pressure side 122A faces the pressure side wall 100A. The suction side 122B faces the suction side wall 100B. The baffle 102 may include apertures (not shown in FIG. 4; see FIGS. 6-8) extending through the baffle body 118 from the inner surface 120 to the outer surface 122, for example, along the pressure side 122A and/or the suction side 122B. The baffle 102 is configured to distribute and direct air flow within the internal cavity 112 (e.g., within the inner cavity portion 112A and the outer cavity portion 112B) to facilitate improved convective heat transfer from the vane body 100.

The gas seal 96 may be mounted to or otherwise disposed at (e.g., on, adjacent, or proximate) and radially inward of the inner ring 92. The gas seal 96 may further form and seals the rotor cavity 86. In particular, the gas seal 96 may seal the rotor cavity 86 from the combustion gas flow through the core flow passage 78. The gas seal 96 of FIG. 3 includes a seal body 124, a first seal member 126 (e.g., a carbon seal), and a second seal member 128 (e.g., a carbon seal). The seal body 124, the first seal member 126, and the second seal member 128 may extend circumferentially about (e.g., completely around) the rotational axis 44, for example, as a full hoop or as circumferential segments. The first seal member 126 and the second seal member 128 may be mounted on the seal body 124. The first seal member 126 may be disposed in sealing contact with the rotor disk 74, for example, at a knife edge 130 of the rotor disk 74. Similarly, the second seal member 128 may be disposed in sealing contact with the rotor disk 80, for example, at a knife edge 132 of the rotor disk 74.

Each of the TCA ports 88 may be connected in fluid communication with a pressurized air source 134 by a TCA pipe 136 mounted on the engine case 70 at the respective one of the TCA ports 88. The air source 134 may be, for example, a discharge or intermediate stage of the low-pressure compressor 30A or the high-pressure compressor 30B. The air source 134 is configured to direct pressurized cooling air 138 (e.g., compressor bleed air) through the TCA pipe 136 for each of the TCA ports 88 to the turbine vane stage 72 (e.g., the baffle 102 of each of the turbine vanes 94) to facilitate cooling of the turbine vane stage 72 (e.g., the vane body 100 of each of the turbine vanes 94).

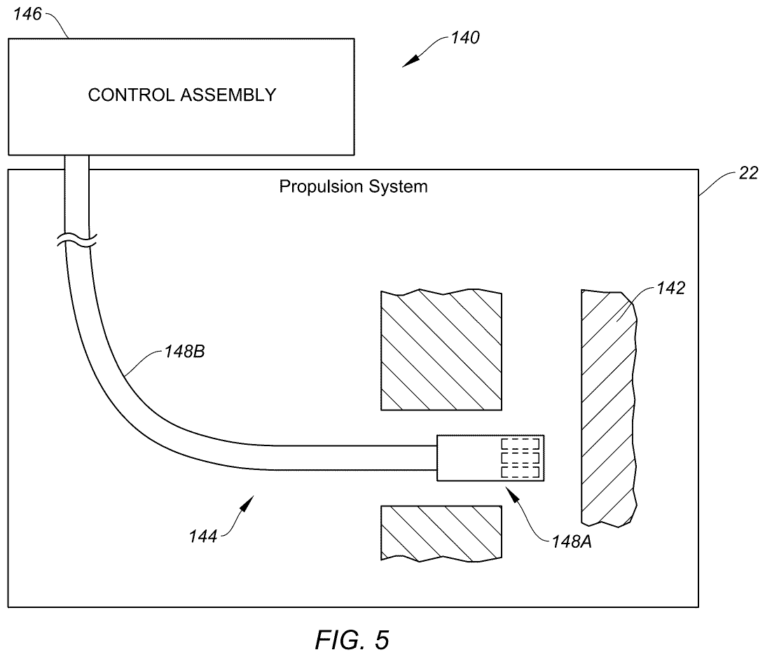

FIG. 5 schematically illustrates an exemplary inspection system 140 for inspecting a component 142 of the aircraft propulsion system 22 such as, but not limited to, the rotor disks 74, 80 (see FIG. 3). The inspection system 140 may be configured to facilitate inspection of the component 142 while the component 142 remains installed with the propulsion system 22 on the aircraft 20 (e.g., the propulsion system 22 remains installed on wing, on fuselage, in airframe, etc.). The component 142, for example, may be disposed within an interior (e.g., an enclosed volume, an encased volume, etc.) of the propulsion system 22. Inspection of the component 142 may also be performed using the inspection system 140 while outside of an aircraft hangar and/or a dedicated inspection and/or repair facility (e.g., on a tarmac at an airport between aircraft flights). Inspection of the component 142 may thereby be performed with a relatively short aircraft downtime and/or a relatively minimal expense. The inspection system 140, of course, may also be used for inspecting the component 142 installed with the propulsion system 22 when that propulsion system 22 is not installed with the aircraft 20 (e.g., prior to installation with the aircraft 20 or following removal from the aircraft 20) or with the component 142 removed from the propulsion system 22. Inspection of the component 142 using the inspection system 140 may facilitate the identification of one or more internal defects of the component 142 such as cracks, voids, etc. (e.g., embedded within material of) the component 142. The term “defect,” as used herein, shall refer to a physical anomaly present within a component (e.g., the component 142) which negatively affects the useful life or performance of the component.

The component 142 may be any inspectable (e.g., metal) component within the propulsion system 22. However, for ease of description, the component 142 may be described below as a rotor disk (e.g., one or both of the rotor disk 74 or the rotor disk 80). The rotor disk may be a turbine disk such as a rotor disk in a high-pressure turbine (HPT) or a low-pressure turbine (LPT) of a gas turbine engine. Alternatively, the rotor disk may be a compressor disk such as a rotor disk in a low-pressure compressor (LPC) or a high-pressure compressor (HPC) of a gas turbine engine. The present disclosure, however, is not limited to such exemplary component 142 configurations. The component 142, for example, may alternatively be configured as a hub, a shaft or any rotating component within the propulsion system 22.

The inspection system 140 of FIG. 5 is configured as an ultrasonic testing (UT) system. For example, the inspection system 140 may be configured for ultrasonic testing, process compensated resonance testing (PCRT), and/or other non-destructive testing (NDT) techniques involving application of ultrasonic vibration to a test object (e.g., the component 142). The inspection system 140 of FIG. 5 includes a probe assembly 144 and a control assembly 146.

The probe assembly 144 may be a borescope probe assembly configured for insertion into the propulsion system 22 (e.g., the gas turbine engine 24) for inspection of the component 142. However, the probe assembly 144 of the present disclosure is not limited to borescope probe assembly configurations. The probe assembly 144 of FIG. 5, for example, includes a probe 148A (e.g., a UT probe) and a guide tube 148B. The probe 148A may include one or more ultrasonic actuators and/or sensors (e.g., piezoelectric transducers). The guide tube 148B may extend all or a substantial portion of a distance from the probe 148A to the control assembly 146. The guide tube 148B may be configured as a conduit to house and protect wiring extending between the probe 148A and the control assembly 146. The guide tube 148B may be a flexible body. For example, the guide tube 148B may include one or more internal actuators for manipulating a configuration of the guide tube 148B to aid in maneuvering the probe 148A and the guide tube 148B within the propulsion system 22 to the component 142.

Inspection of the component 142, for example, the rotor disk 74 and/or the rotor disk 80, may require probe (e.g., the probe 148) access to portions of the gas turbine engine 24 which may typically be inaccessible with the gas turbine engine 24 in an assembled state. Conventionally, inspection of similar gas turbine engine components may require disassembly of substantial portions of the gas turbine engine. These conventional inspection practices may preclude inspection of the gas turbine engine components while the gas turbine engine is installed with a propulsion system on wing or otherwise off wing but in a substantially assembled state, thereby greatly increasing maintenance, inspection, and repair times as well as extending aircraft on ground (AOG) time. In some cases, one or both of the rotor disks 74, 80 may be inspected by inserting a probe (e.g., the probe 148) into the rotor cavity 86 through one of the turbine vanes 94. For example, the probe 148 may be inserted through one of the TCA ports 88, or another access port of the engine case 70, into and through the vane body 100 and its internal cavity 112, to the rotor cavity 86. Access for the probe 148 through the vane body 100 may require drilling or otherwise forming a probe aperture through portions of the particular one of the turbine vanes 94, for example, through the vane body 100 (e.g., at the inner radial end 110) and/or through the seal body 124. Forming this probe aperture and/or inserting the probe 148 into and through the vane body 100 may, in turn, require removal of the internal baffle 102 from the vane body 100. Conventionally, turbine vane baffles may be permanently fixed within the associated vane body, for example, by welding (e.g., using one or more tack welds) the baffle to the vane body. Accordingly, removal of these conventional baffles may require machining or other destructive techniques which risk damage to the vane body and which complicate inspection techniques which may include insertion of inspection components through the vane body, particularly for on-wing gas turbine engine inspections.

Referring to FIGS. 6 and 7, the present disclosure baffle 102 is configured for secure retention within the internal cavity 112 without the need for welds or other permanent attachment features between the baffle 102 and the vane body 100. FIG. 6 illustrates a perspective view of the baffle 102. FIG. 7 illustrates a cutaway, side view of the baffle 102 installed in the vane body 100.

The baffle 102 may include at least one protruding retention feature 150. The protruding retention feature 150 of FIGS. 6 and 7 is configured as a retention tab 152 formed by the baffle body 118. For example, the baffle 102 of FIGS. 6 and 7 includes a first retention tab 152A and a second retention tab 152B; however, the present disclosure is not limited to any particular quantity of the retention tab 152. On the baffle 102 of FIGS. 6 and 7, the first retention tab 152A is disposed on the pressure side 122A and the second retention tab 152B is disposed on the suction side 122B. The retention tab 152 may be disposed proximate the outer radial end 114 as shown in FIGS. 6 and 7. The present disclosure, however, is not limited to the foregoing exemplary positions of the retention tabs 152, 152A-B on the baffle 102. For example, the protruding retention feature 150 (e.g., the retention tabs 152) may additionally or alternatively be disposed on a leading edge of the baffle 102, a trailing edge of the baffle 102, proximate the inner radial end 116, or any other suitable position on the baffle 102. The retention tab 152 projects outward from surrounding portions of the baffle body 118 (e.g., the outer surface 122). For example, the first retention tab 152A projects outward from the pressure side 122A (e.g., toward the adjacent pressure side wall 100A). Similarly, for example, the second retention tab 152B projects outward from the suction side 122B (e.g., toward the adjacent suction side wall 100B).

The retention tab 152 may be formed by a cutout portion of the baffle body 118 such that the baffle body 118 forms an aperture 154 through the baffle body 118 coincident with the retention tab 152, 152A-B. The aperture 154 extends through the baffle body 118 from the inner surface 120 to the outer surface 122 and may, therefore, facilitate directing cooling air flow from the inner cavity portion 112A to the outer cavity portion 112B. As shown in FIG. 6, the aperture 154 may be one of a plurality of apertures 156 formed by the baffle body 118 and extending through the baffle body 118 from the inner surface 120 to the outer surface 122. The retention tab 152 of FIGS. 6 and 7 extends between and to an inner radial end 158 of the retention tab 152 and an outer radial end 160 of the retention tab 152 and between and to a first lateral end 162 of the retention tab 152 and a second lateral end 164 of the retention tab 152. The inner radial end 158 of the retention tab 152 is formed by a bend 166 of the baffle body 118 which interconnects the retention tab 152 with the remainder of the baffle body 118. The retention tab 152 is flared outward from the surrounding portions of the baffle body 118 along the bend 166 such that the retention tab 152 projects outward from the surrounding portions of the baffle body 118 (e.g., the outer surface 122), in a direction from the inner radial end 158 to the outer radial end 160. Each of the outer radial end 160, the first lateral end 162, and the second lateral end 164 is separated (e.g., cut, discontinuous, etc.) from the surrounding portions of the baffle body 118.

FIG. 7 illustrates a cutaway, side view showing the vane body 100 in greater detail. The internal cavity 112 is formed by the vane body 100, for example, by and between the pressure side wall 100A and the suction side wall 100B. In particular, the vane body 100 includes an interior side 168 forming and circumscribing the internal cavity 112 between the outer radial end 108 and the inner radial end 110. The vane body 100 of FIG. 7 includes a plurality of ribs 170. The ribs 170 may extend on and along the pressure side wall 100A and the suction side wall 100B (e.g., in the chordwise direction). The ribs 170 extend inward from the interior side 168 toward and contacting the baffle 102. The ribs 170 are radially distributed on the pressure side wall 100A and the suction side wall 100B along the internal cavity 112. For example, the ribs 170 may be radially staggered with the apertures 156 such that each of the ribs 170 contact the baffle body 118 at a position radially between the apertures 156. The ribs 170 facilitate secure positioning of the baffle 102 within the internal cavity 112 as well as guiding air flow through the outer cavity portion 112B between the vane body 100 and the baffle body 118.

The vane body 100 may further form at least one retention feature recess 172 at the interior side 168 for each respective retention tab 152. For example, the vane body 100 of FIG. 7 includes a first retention feature recess 172A for the first retention tab 152A and a second retention feature recess 172B for the second retention tab 152B. The first retention feature recess 172A is disposed at the pressure side wall 100A. The second retention feature recess 172B is disposed at the suction side wall 100B. The retention feature recess 172 may be disposed proximate the outer radial end 108. For example, the retention feature recess 172 may be disposed radially outward of the ribs 170. However, as with the protruding retention feature 150 (e.g., the retention tabs 152), the retention feature recess 172, 172A-B may additionally or alternatively be disposed on a leading edge of the baffle 102, a trailing edge of the baffle 102, proximate the inner radial end 116, or any other suitable position corresponding to the respective positions of the protruding retention features 150. The retention feature recess 172 is formed, in part, by a rim 174 of the vane body 100 at an outer radial end 176 of the retention feature recess 172.

The present disclosure baffle 102 facilitates simplified installation and removal of the baffle 102 from the vane body 100 compared to conventional vane and baffle assemblies. To install the baffle 102, the baffle 102 may simply be radially inserted into the vane body 100 (e.g., the internal cavity 112), for example, through the outer radial end 108. The baffle 102 may be radially inserted into the vane body 100 until the protruding retention feature(s) 150 expand, deflect, or otherwise extend into the respective retention feature recess(es) 172. With baffle 102 installed in the vane body 100 (e.g., the internal cavity 112) as shown in FIG. 7, the retention tab 152 (e.g., the outer radial end 160) is disposed within the retention feature recess 172 at (e.g., on, adjacent, or proximate) the rim 174, thereby radially retaining the baffle 102 in place within the vane body 100. For example, radially outward movement of the baffle 102 from this installed condition will be opposed by the retention tab 152 (e.g., the outer radial end 160) abutting the rim 174. The baffle 102 may be removed from the vane body 100 (e.g., by a technician or other operator), by depressing the retention tab 152 (or retention tabs 152), or by otherwise deforming the baffle body 118, to separate the retention tab 152 from the retention feature recess 172 and radially withdrawing the baffle 102 from the vane body 100. For example, the baffle 102 may be removed from the vane body 100 and the gas turbine engine 24 through one of the TCA ports 88 (see FIG. 3) or another access port of the gas turbine engine 24. This configuration of the baffle 102 facilitates secure retention of the baffle 102 within the vane body 100 without the need for welds or other permanent attachment features between the baffle 102 and the vane body 100, thereby greatly simplifying installation and removal of the baffle 102 from the vane body 100 (e.g., in preparation for an inspection process for the bladed first turbine rotor 50).

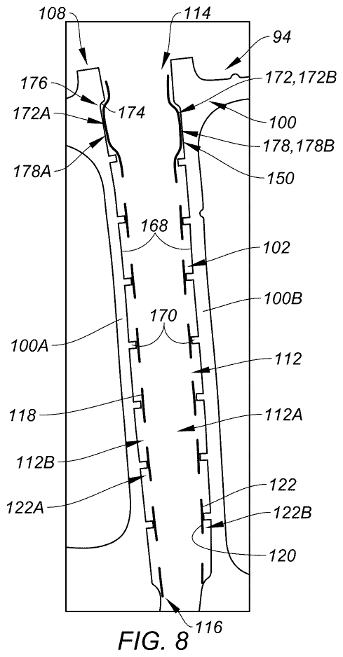

Referring to FIG. 8, another embodiment of the baffle 102 configured for secure retention within the internal cavity 112 without the need for welds or other permanent attachment features between the baffle 102 and the vane body 100 is shown. The protruding retention feature 150 of FIG. 8 is configured as a protruding segment 178 (e.g., a bulge) formed by the baffle body 118. For example, the baffle 102 of FIG. 8 includes a first protruding segment 178A and a second protruding segment 178B; however, the present disclosure is not limited to any particular quantity of the protruding segment 178. The first protruding segment 178A is disposed on the pressure side 122A. The second protruding segment 178B is disposed on the suction side 122B. The protruding segment 178 may be disposed proximate the outer radial end 114 as shown in FIG. 8. In contrast to the retention tab 152 of FIGS. 6 and 7, the protruding segment 178 may be formed by a continuous (e.g., uncut) portion of the baffle body 118. The protruding segment 178 may include distorted portion of the baffle body 118 which projects (e.g., bulges) outward from surrounding portions of the baffle body 118 (e.g., the outer surface 122). For example, the first protruding segment 178A projects outward from the pressure side 122A (e.g., toward the adjacent pressure side wall 100A). Similarly, for example, the second protruding segment 178B projects outward from the suction side 122B (e.g., toward the adjacent suction side wall 100B).

With baffle 102 installed in the vane body 100 (e.g., the internal cavity 112) as shown in FIG. 8, the protruding segment 178 is disposed within the retention feature recess 172 at (e.g., on, adjacent, or proximate) the rim 174, thereby radially retaining the baffle 102 in place within the vane body 100. For example, radially outward movement of the baffle 102 from this installed condition will be opposed by the protruding segment 178 abutting the rim 174. The baffle 102 may be radially inserted into the vane body 100 until the outwardly projecting protruding segment 178 expands into the retention feature recess 172 during insertion. The baffle 102 may be removed from the vane body 100 (e.g., by a technician or other operator), by depressing the protruding segment 178 (or protruding segments 178), or by otherwise deforming the baffle body 118, and radially withdrawing the baffle 102 from the vane body 100.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected, or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims, and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures-- such as alternative materials, structures, configurations, methods, devices, and components, and so on-- may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. A turbine vane of a gas turbine engine for an aircraft propulsion system, the turbine vane comprising:
a vane body extending between and to an outer radial vane end and an inner radial vane end, the vane body including an inner side forming an internal cavity extending through the vane body between the outer radial vane end and the inner radial vane end, the vane body further forming at least one retention feature recess on the inner side; and
a baffle disposed within the internal cavity, the baffle extending between and to an outer radial baffle end and an inner radial baffle end, the baffle including a tubular baffle body extending between and to the outer radial baffle end and the inner radial baffle end, the tubular baffle body subdividing the internal cavity into an outer cavity portion and an inner cavity portion, the outer cavity portion formed between the inner side and the baffle tubular baffle body, the inner cavity portion circumscribed by the tubular baffle body, the tubular baffle body including at least one protruding retention feature, the at least one protruding retention feature disposed within the at least one retention feature recess, the at least one protruding retention feature disposed within the at least one retention feature recess obstructing radial movement of the baffle relative to the vane body;
wherein the at least one retention feature recess is recessed from surrounding portions of the inner side, the vane body includes a rim forming an outer radial recess end of the at least one retention feature recess, and the at least one protruding retention feature projects outward from surrounding portions of the tubular baffle body into the at least one retention feature recess at the rim.

2. The turbine vane of claim 1, wherein the vane body includes a pressure side wall and a suction side wall, the pressure side wall and the suction side wall include portions of the inner side forming the internal cavity, and one or both of the pressure side wall or the suction side wall forms the at least one retention feature recess.

3. The turbine vane of claim 2, wherein the tubular baffle body includes an outer surface forming the outer cavity portion, the outer surface includes a baffle pressure side and a baffle suction side, the baffle pressure side faces the pressure side wall, the baffle suction side faces the suction side wall, and the at least one protruding retention feature is disposed on one or both of the baffle pressure side or the baffle suction side.

4. The turbine vane of claim 1, wherein the at least one retention feature recess includes a first retention feature recess and a second retention feature recess, the at least one protruding retention feature includes a first protruding retention feature and a second protruding retention feature, the first protruding retention feature is disposed within the first retention feature recess, and the second protruding retention feature is disposed within the second retention feature recess.

5. (canceled)

6. The turbine vane of claim 1, wherein the at least one protruding retention feature includes a retention tab formed by the tubular baffle body, the retention tab projects into the at least one retention feature recess and obstructs radial movement of the baffle relative to the vane body.

7. The turbine vane of claim 6, wherein the retention tab extends between and to an inner radial tab end and an outer radial tab end and between and to a first lateral tab end and a second lateral tab end, the inner radial tab end is formed by a bend of the tubular baffle body interconnecting the retention tab with a remainder of the tubular baffle body, and each of the outer radial tab end, the first lateral tab end, and the second lateral tab end is separated from surrounding portions of the tubular baffle body.

8. The turbine vane of claim 7, wherein the tubular baffle body forms an aperture coincident with the retention tab, and the aperture extends through the tubular baffle body from the inner cavity portion to the outer cavity portion.

9. The turbine vane of claim 1, wherein the at least one protruding retention feature includes a protruding bulge segment formed by the tubular baffle body, and the protruding bulge segment extends into the at least one retention feature recess and obstructs radial movement of the baffle relative to the vane body.

10. The turbine vane of claim 9, wherein the protruding bulge segment is formed by a continuous portion of the tubular baffle body.

11. A method for installing a removable baffle into a turbine vane of a gas turbine engine of an aircraft propulsion system, the method comprising:
inserting the baffle into an internal cavity of the turbine vane; and
installing the baffle in the turbine vane by inserting the baffle until at least one protruding retention feature of the baffle expands into at least one retention feature recess formed by a vane body of the turbine vane, the vane body forming the internal cavity of the turbine vane with the at least one retention feature recess disposed coincident with the internal cavity;
wherein the baffle is removable from the vane body by depressing the at least one protruding retention feature and radially withdrawing the baffle from the vane body.

12. The method of claim 11, further comprising accessing the turbine vane through an access port of an engine case of the gas turbine engine prior to installing the baffle in the internal cavity, wherein installing the baffle into the turbine vane further includes installing the baffle into the gas turbine engine through the access port.

13. The method of claim 12, wherein the steps of accessing the turbine vane and installing the baffle are performed with the propulsion system installed on an aircraft.

14. The method of claim 11, further comprising inspecting a bladed turbine rotor of the gas turbine engine disposed adjacent the turbine vane, wherein installing the baffle into the turbine vane is performed subsequent to inspecting the bladed turbine rotor.

15. A gas turbine engine for an aircraft propulsion system, the gas turbine engine comprising:
a bladed turbine rotor rotatable about a rotational axis of the gas turbine engine, the bladed turbine rotor including an upstream rotor stage and a downstream rotor stage; and
a turbine vane stage disposed axially between the upstream rotor stage and the downstream rotor stage, the turbine vane stage including a plurality of turbine vanes, at least one of the plurality of turbine vanes including a vane body and a baffle, the vane body extending between and to an outer radial vane end and an inner radial vane end, the vane body including an inner side forming an internal cavity extending through the vane body between the outer radial vane end and the inner radial vane end, the vane body further forming at least one retention feature recess on the inner side at the outer radial vane end; and
a baffle disposed within the internal cavity, the baffle including at least one protruding retention feature, the at least one protruding retention feature disposed within the at least one retention feature recess, the at least one protruding retention feature disposed within the at least one retention feature recess obstructing radial movement of the baffle relative to the vane body.

16. The gas turbine engine of claim 15, wherein the at least one protruding retention feature includes a retention tab, the retention tab projects into the at least one retention feature recess and obstructs radial movement of the baffle relative to the vane body.

17. The gas turbine engine of claim 16, wherein the retention tab extends between and to an inner radial tab end and an outer radial tab end and between and to a first lateral tab end and a second lateral tab end, the inner radial tab end is formed by a bend of the baffle with the retention tab projecting outward from the bend into the at least one retention feature recess, and each of the outer radial tab end, the first lateral tab end, and the second lateral tab end is separated from surrounding portions of the baffle.

18. The gas turbine engine of claim 17, wherein the baffle forms an aperture coincident with the retention tab.

19. The gas turbine engine of claim 15, wherein the at least one protruding retention feature includes a protruding bulge segment extending into the at least one retention feature recess and obstructing radial movement of the baffle relative to the vane body.

20. The gas turbine engine of claim 19, wherein the protruding bulge segment is formed by a continuous portion of the baffle.

21. The turbine vane of claim 1, wherein the baffle is configured to be removeable from the vane body.
